(19) United States
(12) Patent Application Publication
(10) Pub. No.: US 2013/0054344 A1
(43) Pub. Date: Feb. 28, 2013

(54) CODE READING APPARATUS, SALES DATA PROCESSING APPARATUS AND SALES DATA PROCESSING METHOD

(71) Applicant: Hitoshi Iizaka, Shizuoka-ken (JP)

(72) Inventor: Hitoshi Iizaka, Shizuoka-ken (JP)

(73) Assignee: TOSHIBA TEC KABUSHIKI KAISHA, Tokyo (JP)

(21) Appl. No.: 13/571,593

(22) Filed: Aug. 10, 2012

(30) Foreign Application Priority Data
Aug. 30, 2011 (JP) 2011-187382

(51) Int. Cl. G06Q 30/00; G06Q 30/02; G06Q 90/00

(52) U.S. Cl. 705/14.38; 235/383; 705/23

(57) ABSTRACT

A code reading apparatus comprises a photographing section configured to image an image, a commodity information reading section configured to read commodity information from a code symbol, an image detection section configured to detect an image suitable for the pattern image from the photographs photographed by the photographing section through pattern recognition by referring to a storage section in which the service information relevant to the service to be provided to a customer is stored in association with a pattern image for pattern recognition on a service display displaying the service, a service information reading section configured to read the service information corresponding to the pattern image suitable for the image detected by the image detection section from the storage section and an information output section configured to output the commodity information read by the commodity information reading section and the service information read by the service information reading section.

### CROSS-REFERENCE TO RELATED APPLICATION

This application is based upon and claims the benefit of priority from Japanese Patent Application No. 2011-187382, filed Aug. 30, 2011, the entire contents of which are incorporated herein by reference.

### FIELD

Embodiments described herein relate to a code reading apparatus, a sales data processing apparatus and a sales data processing method.

### BACKGROUND

In supermarkets and other shops, in order to reduce the abandonment loss of perishable goods, perishable goods are sold at discount prices at closing time, with a discount label printed with a discount rate adhered thereon.

Previously, a code reading apparatus is well known which photographs a barcode and a discount label adhered nearby the barcode with a CCD (Charge Coupled Device) image sensor and the like, and reads a commodity code and the discount information (service information) represented by the discount label (service display label) from the photographed image. The code reading apparatus outputs the read commodity code and discount information to a POS (Point Of Sales) terminal device. The POS terminal device realizes the sales of the commodities at discount prices according to the received commodity code and discount information.

### BRIEF DESCRIPTION OF THE DRAWINGS

FIG. 1 is an external perspective view roughly showing the components of a checkout lane system equipped with the code reading apparatus provided in the present embodiment;

FIG. 2 is a block diagram showing the components of a code reading apparatus;

FIG. 3 is a diagram showing an example of the relationship between a commodity and the photographing area of a camera;

FIG. 4 is a diagram illustrating pattern recognition table;

FIG. 5 is a diagram showing an example of a label selection screen;

FIG. 6 is a diagram showing another example of a label selection screen;

FIG. 7 is a flow chart showing the flow of an information output processing carried out by a code reading apparatus.

### DETAILED DESCRIPTION

In accordance with embodiments described herein, a code reading apparatus comprises a photographing section configured to photograph an object to produce the image of the object, a commodity information reading section configured to read commodity information from a code symbol, an image detection section configured to detect an image suitable for the pattern image from the photographs photographed by the photographing section through pattern recognition by referring to a storage section in which the service information relevant to the service to be provided to a customer is stored in association with a pattern image for pattern recognition on a service display displaying the service, a service information reading section configured to read the service information corresponding to the pattern image suitable for the image detected by the image detection section from the storage section and an information output section configured to output the commodity information read by the commodity information reading section and the service information read by the service, information reading section.

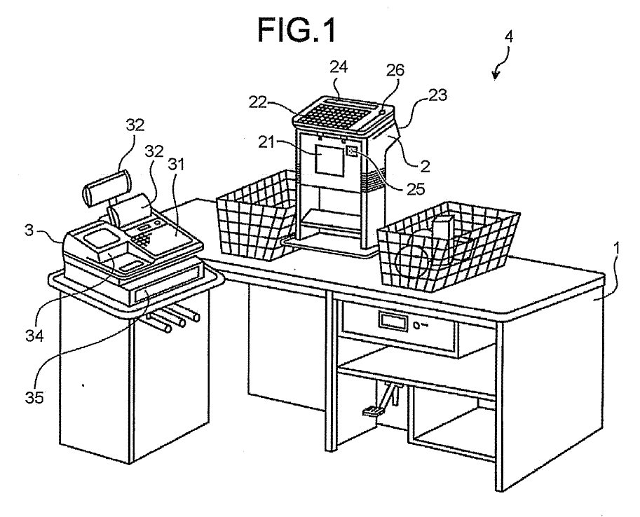

FIG. 1 is an external perspective view roughly showing the components of a checkout lane system 4 provided with the code reading apparatus 2 provided in this embodiment. As shown in FIG. 1, the checkout lane system 4 comprises: a bagging platform 1 installed to hold a commodity-containing shopping basket; a code reading apparatus 2 vertically installed at the substantially central position of the bagging platform 1; and a POS terminal 3 connected with the code reading apparatus 2 by a transmission path (not shown) in a mutually communicable manner.

In the present embodiment, the POS terminal 3 is a sales data processing device which registers the sales of the commodities purchased by a customer. As shown in FIG. 1, a keyboard 31, a display for operator, a display 33 for customer, a printer 34 for printing receipts and a cash drawer 35 for accommodating cash are installed on the POS terminal 3. A total key for the amount settlement of commodities is installed on the keyboard 31. The POS terminal 3 has the same structure and function with the standard POS terminal used in such a checkout lane system. Moreover, the POS terminal is provided with a control section consisting of an ROM, an RAM and a CPU which develops and executes the programs stored in the ROM on the RAM to register the sales of commodities using the commodity codes received from the code reading apparatus.

The code reading apparatus 2 is an apparatus installed to read the barcode printed on a commodity and output the commodity information contained in the barcode to the POS terminal 3. As shown in FIG. 1, the code reading apparatus 2 mainly comprises a reading window 21, a keyboard 22, a display 23 for customer, a shop display 24 for assistant, a buzzer 25 and an LED 26. In the case where a commodity cannot be registered using a barcode, the keyboard 22 accepts the input of various keys.

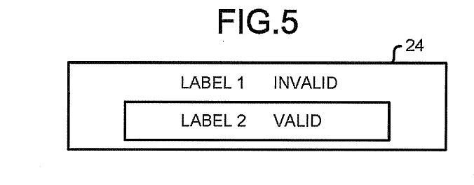

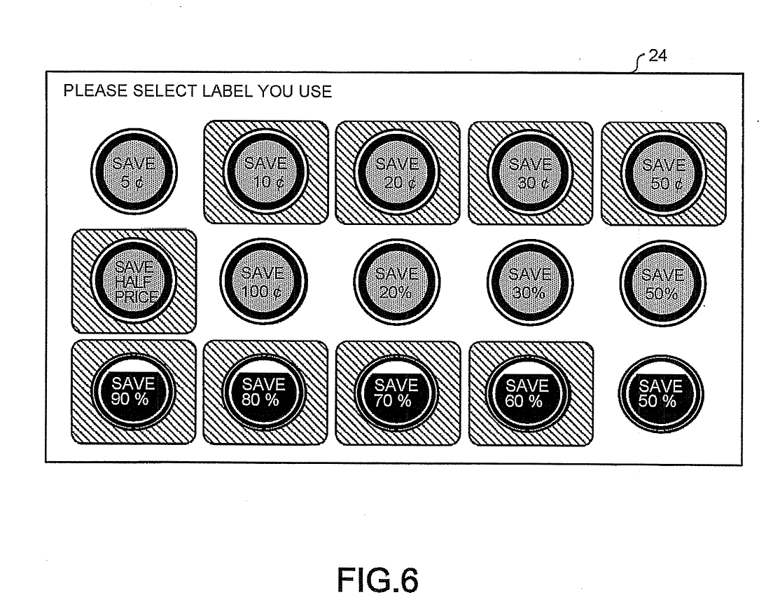

The display 23 for customer is installed to display the name and the price of a registered commodity for a customer. The shop display 24 for assistant is installed to display the name and the price of a registered commodity for a shop assistant. Moreover, the shop display 24 for assistant displays a label selection screen (refer to FIG. 5 and FIG. 6) for registering a service display label (e.g. discount label) that is selected to be used in the shop.

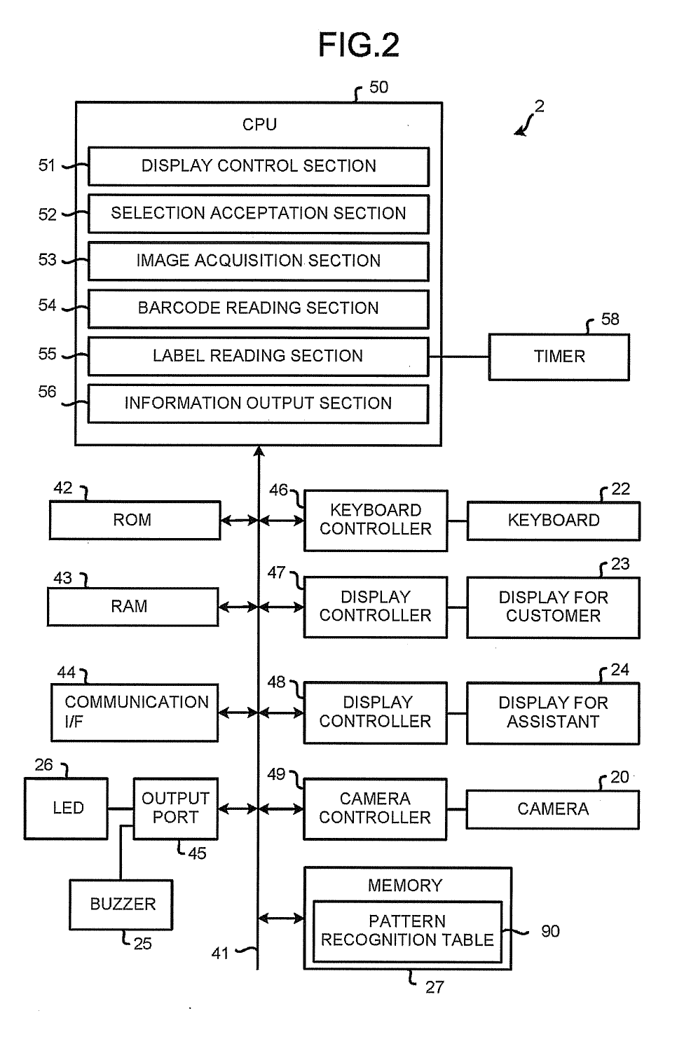

If the barcode printed on a commodity is read, the LED 26 is turned on to inform the operator that the barcode is read, and the buzzer 25 informs the operator of the same event with a warning sound. A CCD (Charge Coupled Device) camera 20 (refer to FIG. 2), which is hereinafter referred to as camera 20 for short, is installed within the code reading apparatus 2 provided with the reading window 21.

FIG. 2 is a block diagram showing the components of the code reading apparatus 2. The code reading apparatus 2 mainly comprises a CPU 50, an ROM 42, an RAM 43, a communication I/F 44, an output port 45, a keyboard controller 46, display controllers 47 and 48, a camera controller 49 and a memory 27, which are connected with each other through a bus line 41 such as an address bus line or a data bus line.

The CPU 50 functions as a control unit to control all the operations of the code reading apparatus 2. The programs used in the present embedment and other programs for controlling the operations of the CPU 50 are stored in the ROM 42. The RAM 43 functions as a working area when the CPU 50 develops the various programs stored in the ROM 42. Moreover, the photographs photographed by the camera 20 and various other data are stored in the RAM 43.

The communication I/F 44 controls the data communication with the POS terminal 3 (refer to FIG. 1) that is connected via the bus line. The output port 45 outputs a drive signal to the buzzer 25 and the LED 26. The keyboard controller 46 acquires a key signal from the keyboard 22. The display controller 47 controls the data display on the display 23 for customer. The display controller 48 controls the data display on the shop display 24 for assistant. The camera controller 49 controls the photographing operations of the camera 20. The camera 20 photographs a code symbol (e.g. barcode or two-dimensional code) and a service display label printed on a commodity, wherein additional services such as discount or points are displayed on the service display label.

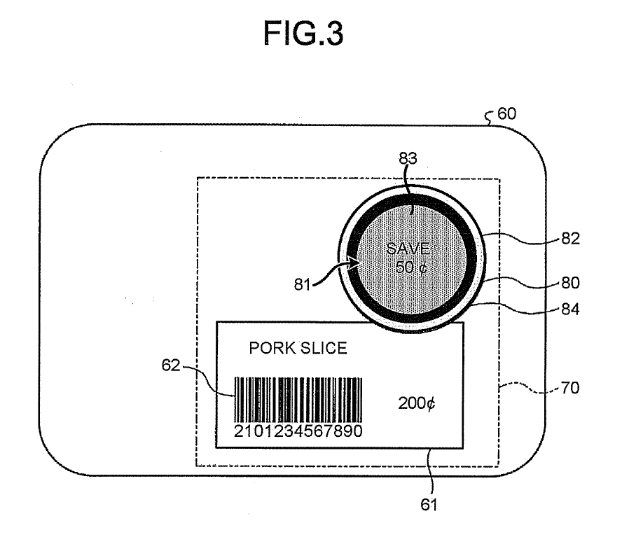

Next, the relationship between a commodity processed by the code reading apparatus 2 described in this embodiment and the photographing area of the camera 20 is described. FIG. 3 is a diagram showing an example of the relationship between a commodity 60 and the photographing area of the camera 20. The area surrounded by the dotted lines in FIG. 3 represents an area that can be photographed by the camera 20 in an image. In addition to a barcode label 61, a discount label 80, which is an example of a service display label, is also adhered on the commodity 60 shown in FIG. 3.

A commodity name, a commodity price and a barcode 62 are displayed on the barcode label 61. A commodity code is compiled in the barcode 62 as the commodity information required by the POS terminal 3 to the sales registration of the commodity 60. Moreover, a commodity code ‘2101234567890’ compiled with the barcode 62 is displayed on the bottom of the barcode 62. The discount label 80 contains service information 81 representing the discount rate of the commodity 60.

The display information 81 may be other service information besides the discount rate so long as it is the service information relevant to the service provided to the customer purchasing the commodity 60. As another example of the service information 81, the discount rate of the commodity 60 or the points provided to the customer purchasing the commodity 60 that is higher than that provided in ordinary cases may be displayed.

As shown in FIG. 3, the discount label 80 includes an outer frame part 82 which surrounds at least part of the service information 81 with, for example, lines or patterns, or a background part 83 which is colored to display the highlighted service information 81 to a customer. Moreover, a blank area 84 is installed outside the outer frame part 82 or the background part 83. As shown in FIG. 3, the existence of the blank area 84 has the following advantages: the image of the discount label can be easily distinguished from other neighboring photographs even the discount label 80 is overlapped with the barcode label 61 or a pattern printed on the packaging of the commodity 60.

In FIG. 2, pattern recognition table 90 is stored in a nonvolatile memory 27 to carry out pattern recognition on a service display label.

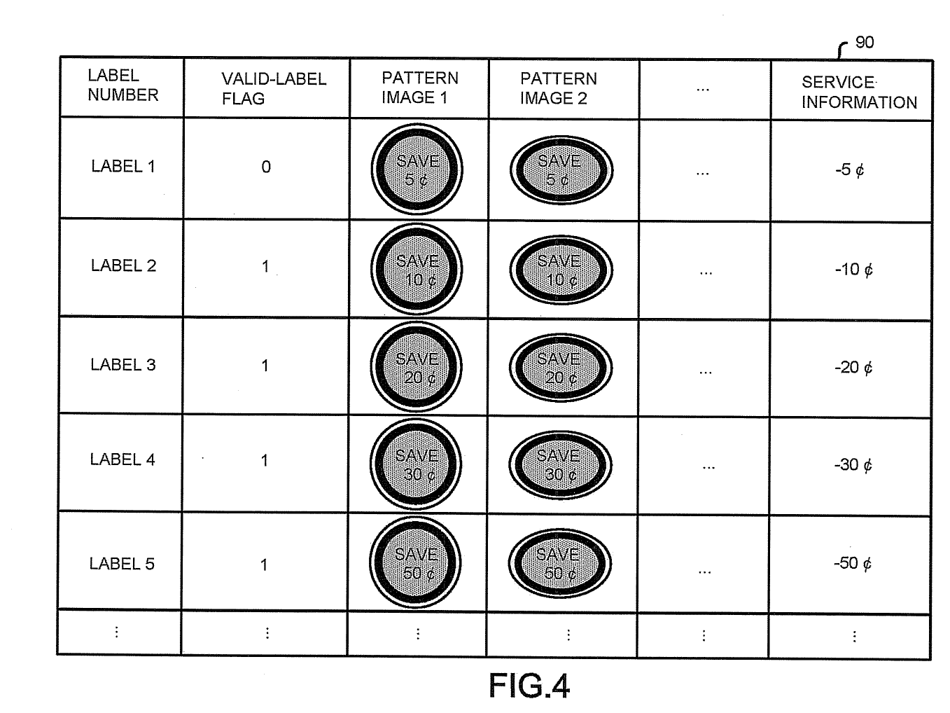

FIG. 4 is a diagram illustrating the pattern recognition table 90. As shown in FIG. 4, in the pattern recognition table 90, each label number for recognizing a label is stored corresponding to a label validation flag for validating the recognition on each service display label, a pattern image for use in pattern recognition on each service display label and service information associated with each service display label.

Each pattern image stored in the pattern recognition table 90 may be stored corresponding to one label, or as shown in FIG. 4, a plurality of pattern photographs may be stored corresponding to one label. That is, in addition to the pattern image 1 shown in FIG. 4 which is photographed by the camera 20 from a service display label that directly faces the camera, the pattern image 2 shown in FIG. 4, which is photographed by the camera 20 from a label display label that is inclined with respect to the vertical direction of the camera 20 (that is, the adhesive surface of the label is not parallel to the surface of the reading window 21), may also be stored as a pattern image. Moreover, although not shown in FIG. 4, an image photographed from a service display label rotating in the peripheral direction thereof may also be stored as a pattern image.

Moreover, the image of a complete label is shown as an example of a pattern image in the example shown in FIG. 4, however, a pattern image is practical as long as it contains at least part of a label. For instance, an image corresponding to the area surrounded by the outer frame part 82 (that is, an image containing no outer frame part 82) may be stored as a pattern image.

Next, the functional units of the code reading apparatus 2 are described below. The CPU 50 acts in accordance with the program stored in the ROM 42 and developed on the RAM 43, thereby functioning as, as shown in FIG. 2, a display control section 51, a selection acceptance section 52, an image acquisition section 53, a barcode reading section 54, a label reading section 55 and an information output section 56.

The display control section 51 and the selection acceptance section 52 set a label validation flag in the pattern recognition table 90.

The display control section 51 (display control section) displays, on the shop display 24 for assistant, a label section screen from which a service display label to be used in the shop is selected from a plurality of service display labels that are pre-registered in the pattern recognition table 90. That is, the label selection screen is a screen provided for a selection on a service display label serving as a reference object for pattern recognition.

FIG. 5 is a diagram showing an example of the label selection screen. Label numbers of the service display labels registered in the pattern recognition table 90 and the settings indicative of whether or not the service display labels are valid are displayed on the label selection screen. Moreover, service display labels 1 and 2 are displayed in FIG. 5, however, other service display labels may also be displayed by scrolling the keys ‘up’ and ‘down’ on the keyboard 22. Further, the number of the service display labels displayed may be changed according to the size of the shop display 24 for assistant.

Further, the label selection screen may be a text screen, as shown in FIG. 5, but are not limited to this. FIG. 6 is a diagram showing another example of the label selection screen. As shown in FIG. 6, photographs roughly representing a plurality of service display labels registered in the pattern recognition table 90 may be displayed on the label selection screen.

The selection acceptance section 52 (selection acceptance section) accepts, based on the label selection screen, the selection on a service display label serving as a reference object for pattern recognition from the service display labels stored in the pattern recognition table 90. More specifically, the selection acceptance section 52 accepts the input of the keyboard 22 through the key controller 46. The operator presses the keys ‘up’, ‘down’, ‘left’ or ‘right’ on the keyboard 22 to select a label from the label selection screen (refer to FIG. 5 and FIG. 6) and sets the selected label to be valid or invalid using the selection key on the keyboard 22. The selection acceptance section 52 sets the label validation flag of a valid label in the pattern recognition table 90 to be 1 (valid) Moreover, the selection acceptance section 52 sets the label validation flag of an invalid label in the pattern recognition table 90 to be 0 (invalid).

The setting method of a label validation flag is not limited to this. According to another setting method, the above-described label selection screen may be displayed on the display 33 (refer to FIG. 1) of the POS terminal 3, and the control section of the POS terminal 3 accepts the selection on the ‘valid’ or ‘invalid’ of a service display label based on the label selection screen. In this case, the selection acceptance section 52 of the code reading apparatus 2 accepts the selection via the communication I/F 44 and sets a label validation flag based on the accepted selection.

Moreover, the selection acceptance section 52 may accept a selection on the ‘valid’ or ‘invalid’ of a service display label without using the above-described label selection screen. For instance, the selection acceptance section 52 may image a valid label using the camera 20 or a code symbol containing the information (label number) relevant to the label and accept the selection on the ‘valid’ or ‘invalid’ setting of the service display label based on the information relevant to the label display label read out of the photographed image.

The image acquisition section 53, the barcode reading section 54, the label reading section 55 and the information output section 56 carry out a barcode reading processing and a label reading processing accompanied with a commodity scanning operation.

The image acquisition unit 53 outputs a photographing-on signal to the camera controller 49 to activate the camera 20 to start a photographing operation. The image acquisition section 53 acquires an image in the area 70 photographed by the camera 20 and stores the acquired image in the image working area of the RAM 43. Moreover, after receiving an instruction from the label reading section 55, the image acquisition section 53 acquires an image in the area 70 photographed by the camera 20 and stores the acquired image in the image working area of the RAM 43.

As shown in FIG. 3, when the barcode 62 and the discount label 80 are adhered close to each other on the commodity 60, the barcode 62 and the discount label 80 are placed in the same photographing area 70. In this case, the camera 20 may image the barcode 62 and the discount label 80 in one image. The image acquisition unit 53 acquires the image corresponding to the photographing area 70 to the image working area of the RAM 43.

Moreover, in the case in which the barcode 62 and the discount label 80 on the commodity 60 are away from each other and are therefore not placed in the same photographing area 70, the operator changes the position of the commodity 60 facing the reading window 21 to image the barcode 62 and the discount label 80 separately. In this case, the image acquisition section 53 respectively acquires an image containing the photographed image of the barcode 62 and an image containing the photographed image of the discount label 80 to the image working area of the RAM 43.
The barcode reading section 54 (commodity information reading section) carries out a barcode reading processing to detect the image of the barcode 62 from the photographs stored in the image working area of the RAM 43 by the image acquisition unit 53 and reads the commodity information of the commodity 60 from the detected barcode 62.

More specifically, the barcode reading section 54 binarizes the image data of the frame 1 stored in the image working area of the RAM 43 and detects whether or not the binarized data contains a data area relevant to the barcode 62. If the data area relevant to the barcode 62 is detected in the acquired image data, the barcode reading section 54 decodes the barcode 62 and reads the resulting multi-bit barcode information (barcode data) as the commodity information of the commodity 60. Moreover, the barcode data contains a manufacturer code, a commodity code serving as commodity information and checking digits. The barcode reading section 54 stores the read barcode data in the RAM 43.

Moreover, the barcode reading section 54 reads commodity information from the code symbol printed on the commodity, however, the present invention is not limited to this, the barcode reading section 54 may read commodity information from a code symbol that is not adhered on a commodity. As an example, the operator may scan, on a paper card on which the codes of a plurality of commodities are recorded, a barcode corresponding to a commodity purchased by a customer, and the barcode reading section 54 stores the read barcode data in the RAM 43.

The label reading section 55 (image detection section and service information reading section) carries out a label reading processing to detect an image suitable for the pattern image stored in the pattern recognition table 90 from the photographs stored in the image working area of the RAM 43 through pattern recognition and reads the service information associated with the detected image from the pattern recognition table 90.

First, the label reading section 55 detects a label area in the photographs stored in the image working area of the RAM 43. As an example, the label reading section 55 carries out pattern recognition on the outer frame part 82 or background part 83 for the discount label 80 shown in FIG. 3, thereby determining whether or not the area is the label area where the service display label exists. Moreover, the label reading section 55 may further detect a label area based on the shape, color or other characteristics of a label.

Further, the label reading section 55 carries out pattern recognition processing for the image in the detected label area based on the pattern photographs stored in the pattern recognition table 90. Moreover, by using the pattern image of the service display label accepted by the selection acceptance section 52 as a reference object for the pattern recognition, the label reading section 55 detects an image suitable for the pattern image of the reference object.

More specifically, the label reading section 55 calculates the degree of the consistency (the similarity) of photographs with reference to (pattern recognition) the image stored in the image working area of the RAM 43 and the pattern image in the pattern recognition table 90 with a label validation flag ‘1’(valid). Moreover, the pattern image with the highest similarity is selected as the one suitable for the service display label.

Further, no specific limitation is given to the method for calculating the similarity, and the conventional common calculation method can be used. As an example, the calculation method described in Patent Document 2 is applicable.

Further, the label reading section 55 reads the service information in association with the selected pattern image with reference to the pattern recognition table 90. Moreover, the label reading section 55 temporarily stores the service information in the RAM 43 in association with the barcode information stored in the RAM 43.

Further, the image acquisition of the image acquisition section 53 only lasts for a given period of time, ending at the moment a service display label is detected by the label reading section 55. That is, the label reading section 55 controls the operations of a timer 58 which times the label reading time. In the case in which no service display label is detected (that is, no label area is detected, or it is determined that there is no pattern image having a similarity above a threshold) and the timer 58 does not expire, the label reading section 55 instructs the image acquisition unit 53 to re-acquire the photographs photographed by the camera 20 in the photographing area 70.

In this way, the operator can image the commodity 60 repeatedly with the camera 20 before the timer 58 expires. Therefore, photographs of the service display label and the barcode label 61 may be separately acquired through different reading operations if the two labels are configured at the positions that cannot be photographed once, thereby acquiring barcode data and service information.

The information output section 56 (information output section) associates the barcode data temporarily stored in the RAM 43 with the service information and then outputs the associated data to the POS terminal 3. Moreover, the information output section 56 only outputs the barcode data to the POS terminal 3 if the timer 58 expires and the service information is not stored in association with the barcode data.

The control section (receiving section) of the POS terminal 3 receives the barcode data or service information from the code reading apparatus 2 connected via a transmission path. Moreover, the control section of the POS terminal 3 reads the price of the commodity 60 corresponding to the barcode data with reference to a commodity master file stored in the POS terminal 3 or a host terminal (not shown) in the shop. Further, the control section (sales registration section) of the POS terminal 3 registers the sales of the commodity by applying the discount or discount information contained in the received service information to the price of the commodity 60. Further, if member points are contained in the service information, the control section of the POS terminal 3 adds the points to the member card of the customer.

Further, the service information may also be associated with the barcode data by the code reading apparatus 2 or the POS terminal 3.

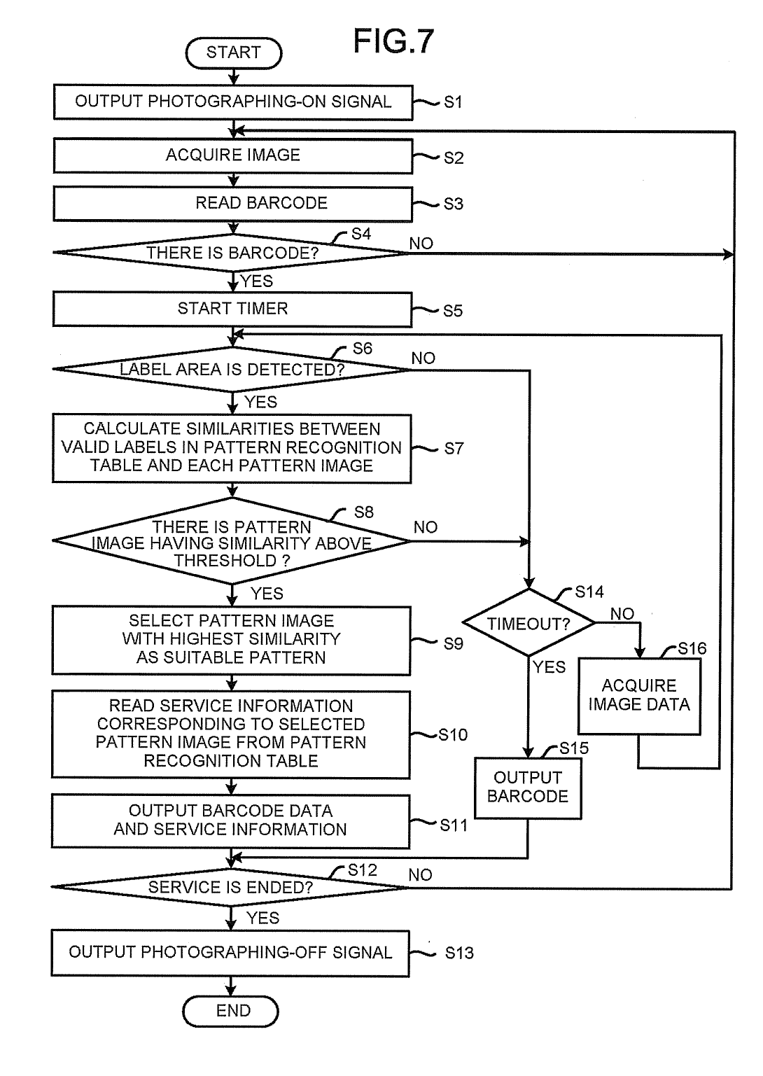

Next, the information output processing carried out by the code reading apparatus 2 is described below. FIG. 7 is a flow chart showing the flow of the information output processing carried out by the code reading apparatus 2.

When instructed to launch a service by an instruction sent from the POS terminal 3, the CPU 50 of the code reading apparatus starts an information output processing. The image acquisition unit 53 outputs a photographing-on signal to the camera controller 49 to activate the camera 20 to start a photographing operation (Act S1). The image acquisition unit 53 acquires the photographs photographed by the camera 20 to the image working area of the RAM 43 (Act S2). Moreover, the barcode reading section 54 starts the barcode reading processing (Act S3).

The barcode reading section 54 determines whether or not the barcode 62 is detected in the barcode reading processing of Act S3 (Act S4). If the barcode 62 is not detected (Act S4: No), the barcode reading section 54 enables the camera 20 to continue to image photographs (Act S2).

If the barcode 62 is detected (Act S4: Yes), the label reading section 55 starts a timer 58 to time the reading of a label (Act S5) and starts the label reading processing. That is, the label reading section 55 starts to detect a label area in the way described above aiming at the image acquired to the image working area of the RAM 43 in Act S2. Moreover, if a label area is detected (Act S6: Yes), the similarity of pattern photographs is calculated with reference to the photographs in the label area and the pattern photographs in the pattern recognition table 90 with a label validation flag ‘1’ (valid) (Act S7).

The label reading section 55 determines whether or not there are pattern image having a similarity above the threshold (Act S8) and if so (Act S8: Yes), selects the pattern image having the highest similarity as the pattern image (suitable pattern) suitable for the image (Act S9). Further, the label reading section 55 reads, from the pattern recognition table 90, the service information corresponding to the selected pattern image (Act S10). Moreover, the information output section 56 associates the barcode data temporarily stored in the RAM 43 with the service information and then outputs the associated data to the POS terminal 3 via the communication I/F 44 (Act S11).

On the other hand, if the label reading section 55 detects no label area (Act S6: No) and there exists no pattern image having a similarity above the threshold (Act S8: No), the label reading section 55 determines whether or not the started timer 58 expires (Act S14).

If the timer 58 does not expire (Act S14: No), the label reading section 55 controls the image acquisition section 53 to re-acquire photographs (Act S16) and then carries out the acts following Act S6.

If the timer 58 expires (Act S14: Yes), the information output section 56 outputs the barcode data stored in the RAM 43 to the POS terminal 3 via the communication I/F 44 (Act S15). Then, the CPU 50 turns to execute Act S12.

The CPU 50 determines, according to a command from the POS terminal 3 (Act S12), whether or not there is an indication indicative of the end of the service. If there is no indication indicative of the end of the service (Act S12: No), the flow returns to Act S2, and Acts S2-S12 are then repeatedly executed until the sales of all the commodities is registered. If there is an indication indicative of the end of the service (Act 512: Yes), the CPU 50 outputs a photographing-off signal to the camera controller 49 (Act S13) to end the photographing operation of the camera 20.

Typically, most of the service display labels used in a shop are pre-defined, as shown in FIG. 6. Therefore, only the label used is needed to be recognized, but not every character or symbol contained in the label. In this embodiment, the pattern photographs of the service display labels used in a shop is stored in the pattern recognition table 90 so that pattern recognition on a label can be carried out with reference to the pattern recognition table 90. As a result, service information can be quickly and easily read without recognizing the characters contained in a label one by one, thus relieving the workload of recognizing a discount label.

In addition, according to the present embodiment described above, the service display label to be used in a shop may be selected from the plurality of service display labels pre-registered in the pattern recognition table 90, which reduces the number of the pattern photographs for reference and further relieves recognition workload.

Further, in the description above, the label reading section 55 reads service information from the service display label after the barcode reading section 54 reads commodity information from the barcode 62, however, the reading order of the two kinds of information is not limited to this. As another example, the barcode reading section 54 may read commodity information from the barcode 62 after the label reading section 55 reads service information from the service display label.

Further, in accordance with the example described above, one service display label is adhered on the commodity 60, however, the number of the service display labels adhered on the commodity 60 may be more than one.

Further, in the description above, the label reading section 55 reads service information from the service display label, however, discount rate and discount information are not limited to be printed on a label. As another example, discount rate and discount information may be directly recorded or printed on the commodity 60.

Further, in the description above, the barcode reading section 54 reads the barcode 62 printed on the commodity 60, however, the present invention is not limited to this, the barcode reading section 54 may further read a code symbol such as a two-dimensional code. Moreover, the barcode 62 may be printed on the barcode label 61 which is then adhered on the commodity 60 or directly printed on the commodity.

Further, the programs executed by the POS terminal 1 and the code reading apparatus 2 in this embodiment are provided such that such programs are stored in an ROM beforehand. The program executed by the POS terminal 1 and the code reading apparatus 2 in this embodiment may also be stored in a computer-readable recording medium such as CD-ROM, FD (floppy drive), CD-R, DVD (digital versatile disk) as an installable or executable file. The program executed by the POS terminal 1 and the code reading apparatus 2 in this embodiment are stored in a computer connected with a network such as the Internet and provided by downloading through the network, or may be provided or distributed through a network such as the Internet.

While certain embodiments have been described, these embodiments have been presented by way of example only, and are not intended to limit the scope of the inventions. Indeed, the novel embodiments may be embodied in a variety of other forms; furthermore, various omissions, substitutions and changes in the form of the embodiments may be made without departing from the spirit of the inventions. The accompanying claims and their equivalents are intended to cover such forms or modifications as would fall within the scope and spirit of the inventions.

As stated above, in accordance with the present embodiment, an image suitable for a pattern image is detected from the photographs photographed by the photographing section through pattern recognition with reference to a storage section in which service information is stored in association with a pattern image for pattern recognition on the service information, and the service information corresponding to the pattern image suitable for the image is read. Thus, by detecting a service display through pattern recognition, the service information can be quickly and easily read without recognizing characters one by one, which results in relieving the workload of recognizing a discount label.

What is claimed is:

1. A code reading apparatus, comprising:
a photographing section configured to image an image;
a commodity information reading section configured to read commodity information from a code symbol;
an image detection section configured to detect an image suitable for the pattern image from the photographs photographed by the photographing section through pattern recognition by referring to a storage section in which the service information relevant to the service to be provided to a customer is stored in association with a pattern image for pattern recognition on a service display displaying the service;
a service information reading section configured to read the service information corresponding to the pattern image suitable for the image detected by the image detection section from the storage section; and
an information output section configured to output the commodity information read by the commodity information reading section and the service information read by the service information reading section.

2. The code reading apparatus according to claim 1, wherein
the storage section stores the service information in association with the pattern image for each of the service displays, and includes a selection acceptance section configured to accept the selection of the image detection section on the service display for pattern recognition from the plurality of service displays stored in the storage section; and
the image detection section detects an image suitable for the pattern image of the reference object from the photographs photographed by the photographing section by taking the pattern image of the selected service display accepted by the selection acceptation section as a reference object.

3. The code reading apparatus according to claim 2, further comprising:
a display control section configured to display a selection screen from which the image detection section selects the service display serving as the reference object for pattern recognition from the plurality of service displays stored in the storage section; wherein
the selection acceptance section accepts the selection on the service display for pattern recognition based on the selection screen.

4. A sales data processing apparatus, comprising:
a receiving section configured to receive the commodity information or the service information from the code reading apparatus described in claims 1; and
a sales registration section configured to register the sales of commodities based on the commodity information and the service information.

5. The sales data processing apparatus according to claim 4, wherein
the service information refers to the discount rate or discount-related information of a commodity; and
the sales registration section registers the sales of the commodity by applying the discount rate or discount-related information contained in the service information to the commodity price corresponding to the commodity information.

6. A sales data processing method for a code reading includes a photographing section configured to image an image, comprising:
reading commodity information from a code symbol;
detecting an image suitable for the pattern image from the photographs photographed by the photographing section through pattern recognition by referring to a storage section in which the service information relevant to the service to be provided to a customer is stored in association with a pattern image for pattern recognition on a service display displaying the service;
reading the service information corresponding to the pattern image suitable for the detected image from the storage section; and
outputting the read commodity information and the read service information.
